(19) United States
(12) Patent Application Publication
(10) Pub. No.: US 2019/0155857 A1
(43) Pub. Date: May 23, 2019

(54) METHOD AND APPARATUS FOR PROCESSING A FILE

(71) Applicant: THOMSON LICENSING, Issy Ies Mounlineaux (FR)

(72) Inventors: Samo KONYAR, Canoga Park, CA (US); Anton Werner KELLER, Arni (CH)

(21) Appl. No.: 15/505,092

(22) PCT Filed: Aug. 22, 2014
(86) PCT No.: PCT/US2014/052234

§ 371 Date: Feb. 19, 2017

(51) Int. Cl. G06F 16/954; H04L 29/08; G06F 16/438; G06F 16/44; G06F 16/45

(52) U.S. Cl. CPC G06F 16/954; H04L 67/2804; H04L 67/02; G06F 16/9558; G06F 16/44; G06F 16/45; G06F 16/438

(57) ABSTRACT

The present principles of the embodiments generally relate to an apparatus and a method for processing a file. In one exemplary embodiment, an electronic file such as e.g., a web page is searched based on one or providing a file containing a more category identifiers selected by a user. The file is processed to identify informational elements corresponding to the user selected category identifiers. If an information element is identified, the file is supplemented with one or more supplemental informational elements to provide a supplemented file. In one exemplary embodiment, the supplemental information elements may relate to one or more of media assets which the user may select to purchase or view.

### BACKGROUND OF THE INVENTION

### Field of the Invention

The present principles of the embodiments generally relate to an apparatus and a method for processing an electronic file. In one exemplary embodiment, a file such as e.g., a webpage is searched based on one or more category identifiers selected by a user. The file is processed to identify informational elements corresponding to the user selected category identifiers. If an information element is identified, the file is supplemented with one or more supplemental informational elements to provide a supplemented file. In one exemplary embodiment, the supplemental information elements may relate to one or more of media assets which the user may select to purchase or view.

### Background Information

It is well known that internet websites such as, e.g., Yahoo.com, Hoffingtonpost.com, Wikipedia.com, and etc., have certain elements on their webpages that when selected by a user, the user will be directed to the internet links associated with these elements using hyperlinks. A hyperlink in computing is a reference to data that a user can directly follow either by clicking or by hovering (e.g., by moving a cursor using a mouse), or that is followed automatically. A hyperlink may point and be referenced to a whole document or a specific element within a document (either in another computer or in the same computer). Hypertext is text with hyperlinks. A software system for viewing and creating hypertext is a hypertext system, and to create a hyperlink is to hyperlink (or simply to link). A user following hyperlinks is said to navigate or browse the hypertext.

In addition, different streaming media sites (e.g., Hulu, Netflix, M-GO, and etc.) currently provide various user interfaces for users to search media assets for view and/or purchase. The users may search e.g., different movies available on these websites by typing in a query string related to the movie titles, using keyboards on their e.g., PCs, laptops, cellphones, various other user devices, and etc.

The existing systems and methods, however, do not allow users to specify which informational elements (e.g., words) in a file (e.g., web page) may be hyperlinked automatically based on one or more user selected categories. The existing systems and methods also do not provide an easy and informative user interface for users to obtain and navigate the information and in particular information related to media assets.

### SUMMARY OF THE INVENTION

The present inventors recognize the needs to improve the existing systems and methods for processing files and in particular information related to media assets.

In accordance with an aspect of the present invention, an apparatus is presented, comprising:

a user interface device for receiving a user input for selecting at least one of a plurality of category identifiers for identifying a plurality of categories; and

a processor for providing a supplemented file; wherein the supplemented file is generated from a file containing a plurality of informational elements, at least one of the plurality of informational elements in the file is identified in response to the at least one of the category identifiers, and the file is supplemented in response to the identified at least one of the plurality of informational elements with at least one supplemental informational element to generate the supplemented file.

In another exemplary embodiment, a method is presented comprising:

providing a file containing a plurality of informational elements; and

receiving a user input for selecting at least one of a plurality of category identifiers for identifying a plurality of categories; and wherein at least one of the plurality of informational elements in the file is identified in response to the at least one of the category identifiers; and the file is supplemented in response to the identified at least one of the plurality of informational elements with at least one supplemental informational element to provide a supplemented file.

In accordance with principles of the present invention, a computer program product stored in a non-transitory computer-readable storage media is presented, comprising computer-executable instructions for:

providing a file containing a plurality of informational elements; and

receiving a user input for selecting at least one of a plurality of category identifiers for identifying a plurality of categories; and wherein at least one of the plurality of informational elements in the file is identified in response to the at least one of the category identifiers; and the file is supplemented in response to the identified at least one of the plurality of informational elements with at least one supplemental informational element to provide a supplemented file.

### DETAILED DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

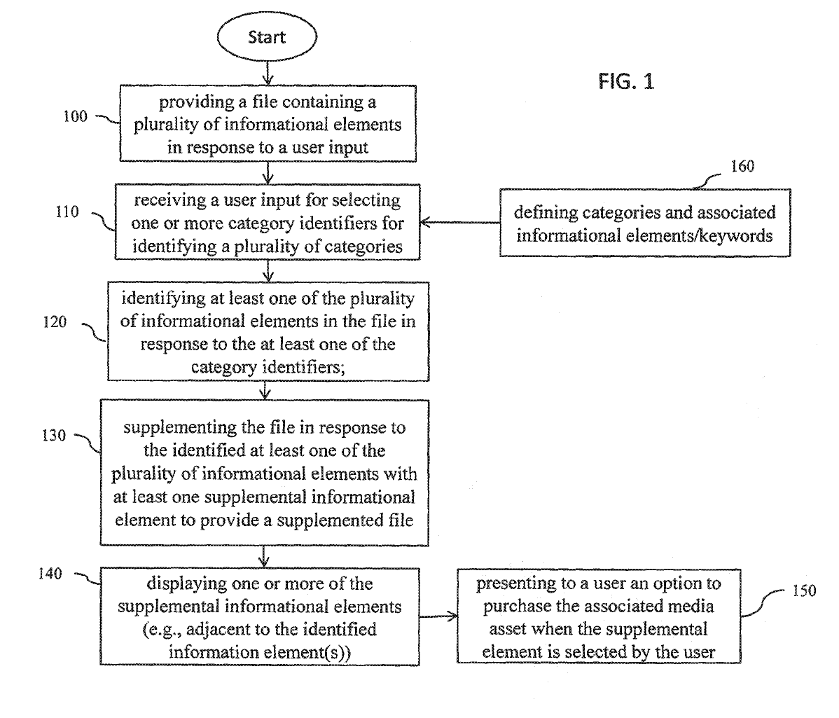

FIG. 1 shows an exemplary process according to the principles of the present invention;

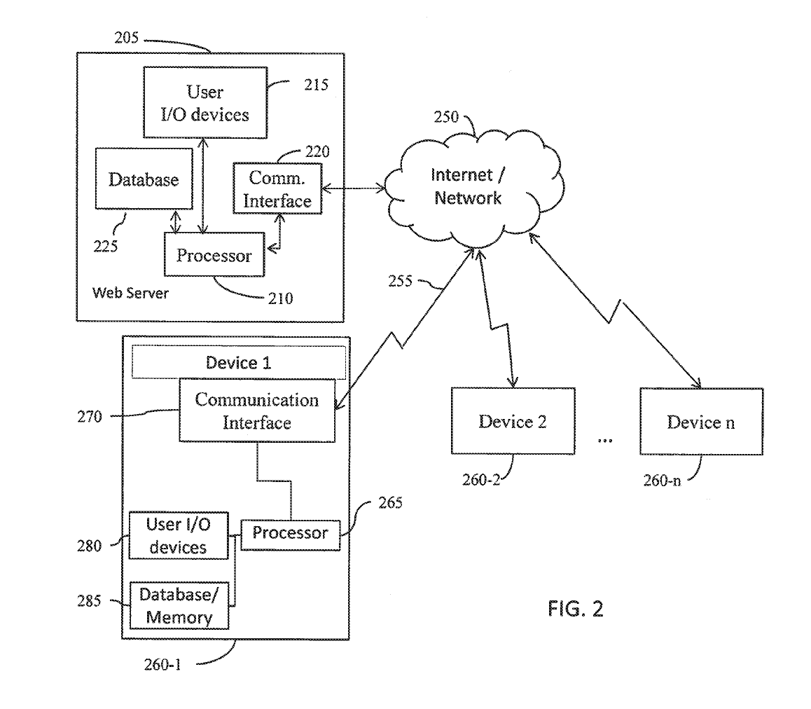

FIG. 2 shows an example system according to the principles of the present invention;

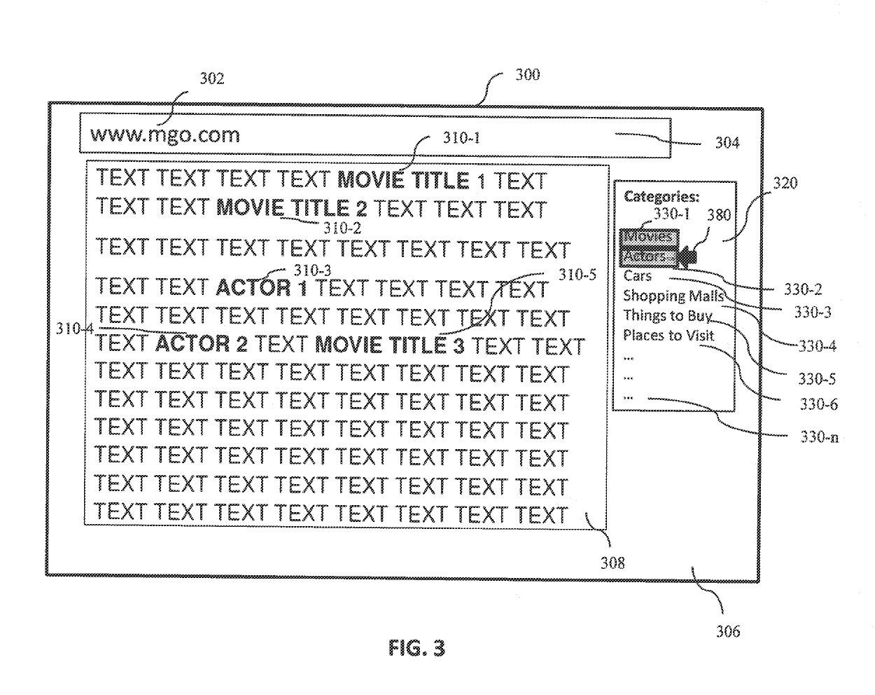

FIG. 3 to FIG. 6 show exemplary user interfaces and their functions of an exemplary electronic device according to the principles of the present invention;

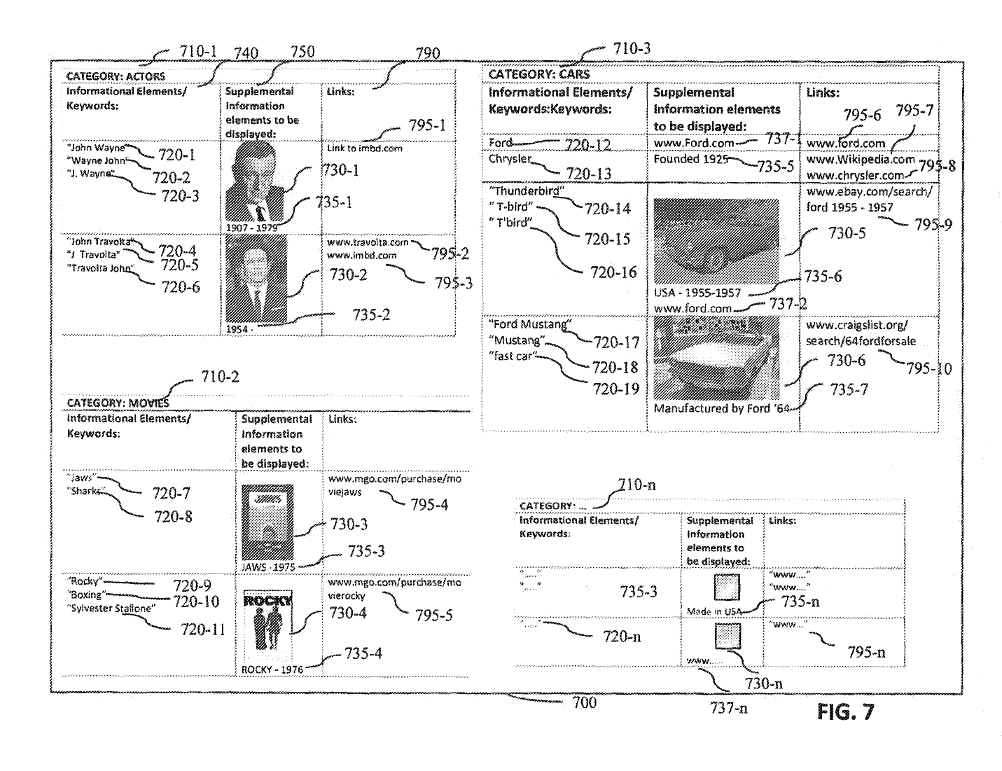

FIG. 7 shows an exemplary data structure for storing information according to the principles of the present invention; and

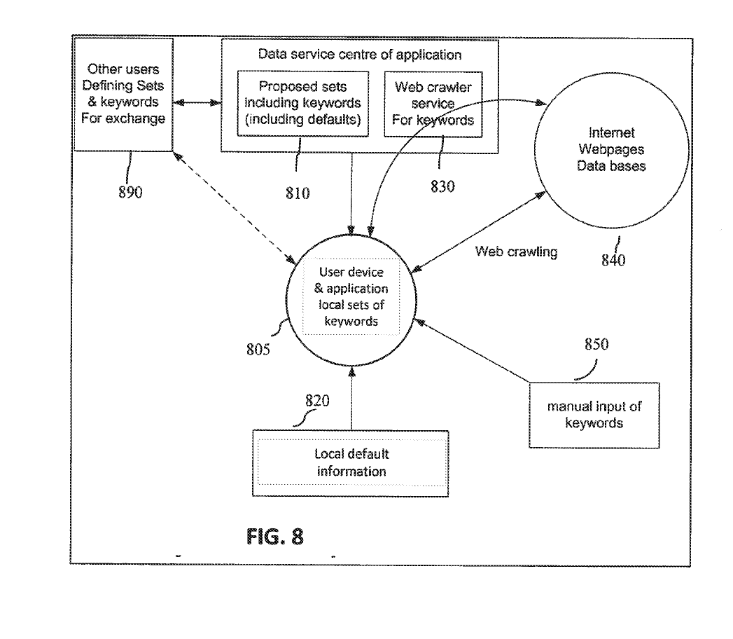

FIG. 8 shows another exemplary process according to the principles of the present invention.

The examples set out herein illustrate exemplary embodiments of the invention. Such examples are not to be construed as limiting the scope of the invention in any manner.

### DETAILED DESCRIPTION

Referring now to the drawings, and more particularly to FIG. 2. FIG. 2 is an exemplary system according to the principles of the present invention. FIG. 2 illustrates, e.g., a system capable of providing an electronic file such as e.g., a web page, from a webserver 205 to a plurality of end user devices 260-1 to 260-n. As used herein, an electronic file is an electronic content or document which may be in various formats and/or in compliance with various standards. An electronic file can be processed by a computer, and may comprise e.g., one or more of: 1) an electronic text document, 2) a web page, 3) a HTML file, 4) an e-mail, 5) a PDF file, 6) a JavaScript file, 7) a Microsoft Word document, and etc.

Various user devices 260-1 to 260-n in FIG. 2 may access a web page over the internet, a wide area network (WAN), and/or a local area network (LAN) 250. The web page service is hosted, e.g., by a web server 205. Web server 205 may be a computer having a processor 210 such as, e.g., an Intel processor, running an appropriate operating system such as, e.g., Windows 2008 R2, Windows Server 2012, Linux operating system, and etc. Devices 260-1 to 260-n may access different web pages provided by server 205 using, e.g., HTTP protocol. A well-known web server application software is Apache HTTP Server software available from http://www.apache.org.

In addition, web server 205 may also provide media content services similar to, e.g., Amazon.com, Netflix, or M-GO. Web server 205 may use a streaming protocol such as e.g., Apple HTTP Live Streaming (HLS) protocol, Adobe Real-Time Messaging Protocol (RTMP), Microsoft Silverlight Smooth Streaming Transport Protocol, and etc., to transmit various media assets such as, e.g., video programs, audio programs, movies, TV shows, software, games, electronic books, electronic magazines, electronic articles, and etc., to an end-user device 260-1 for purchase and/or view.

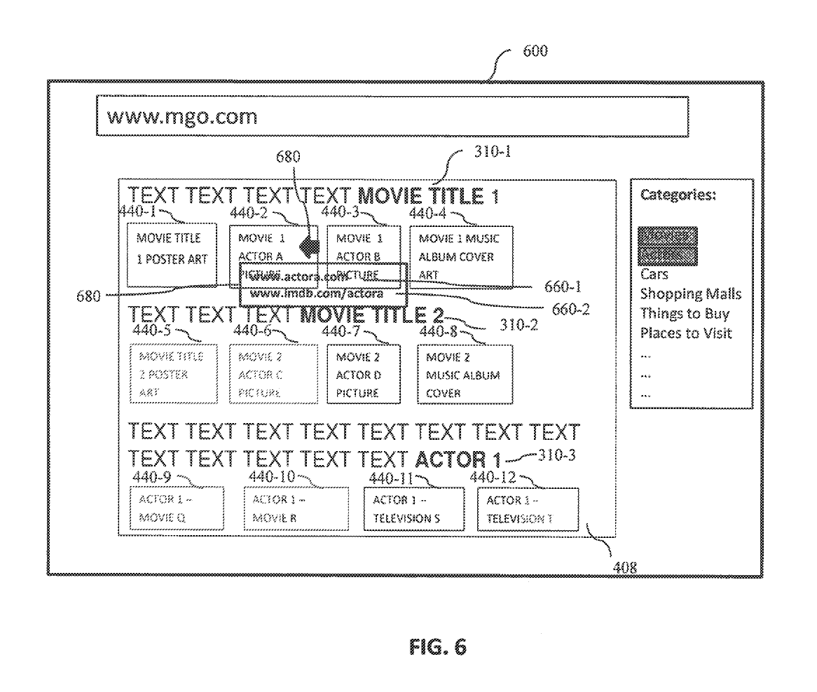

In addition, a user (e.g., a web server administrator) may interact with and configure web server 205 using user I/O devices 215 (e.g., a keyboard and/or a display) as well known in the art. Furthermore, various webpages, media assets and their associated metadata (e.g., webpage and media assets related information) may be stored in a database 225 and accessed by processor 210 as needed. In particular, database 225 may store a plurality of categories and their associated informational elements/keywords as shown in FIG. 6 and FIG. 7, to be described in detail later. Database 225 may reside in appropriate storage media, such as, e.g., one or more hard drives and/or other suitable memory devices, as well known in the art.

Server 205 is connected to, e.g., the internet, a wide area network (WAN), or a local area network (LAN) 250 through a communication interface 220 for connecting to other web sites and to one or more user devices 260-1 to 260-n, as shown in FIG. 2. In addition, one skilled in the art would readily recognize that other server components, such as, e.g., RAM memories, may also be needed, but are not shown in FIG. 2 to simplify the drawing.

User devices 260-1 to 260-n shown in FIG. 2 may comprise one or more of, e.g., a PC, a laptop, a tablet, a cellphone, and etc. One of such devices may be, e.g., a Microsoft Windows 7 or Windows 8 computer, an Android phone (e.g., Samsung S3, S4, or S5), an Apple IOS phone (e.g., IPhone 5S or 5C), or an Apple IPad. For example, a detailed block diagram of an exemplary device according to the principles of the present invention is illustrated in block 260-1 of FIG. 2.

Device 260-1 comprises a processor 265 for processing various data and for controlling various functions and components of the device 260-1. In additional, device 260-1 also comprises user I/O devices 280 which may include, e.g., a touch and/or a physical keyboard for inputting user data, and/or a display and/or a speaker for outputting visual and/or audio user data and feedback. Device 260-1 also comprises a memory 285 for processing and storing different files and information as necessary, including webpages and user interface information shown in FIG. 3 to FIG. 6, and relevant information in an exemplary data structure of a database shown in FIG. 7 and to be described later. Device 260-1 also comprises a communication interface 270 for connecting and communicating to/from web server 205 and other web sites and devices, via, e.g., the internet, WAN or LAN 250 using e.g., a cable network, a FIOS network, a Wi-Fi network, and/or a cellphone network (e.g., 3G, 4G, LTE), and etc.

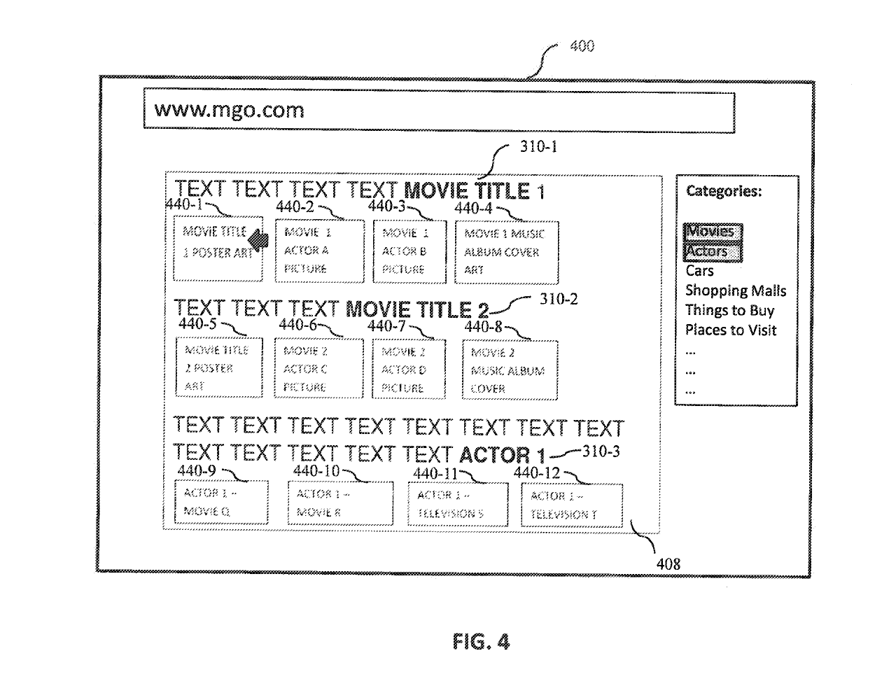

FIG. 3 to FIG. 6 illustrate exemplary user interface screens and functions according to the principles of the present invention. These user interface screens and functions may be controlled and/or provided by e.g., processor 265 in device 260-1 of FIG. 4 and/or processor 210 in web server 205 remotely.

FIG. 1 is a flow chart of an exemplary process according to principles of the present invention. In one embodiment, the exemplary process may be implemented as computer executable instructions which may be executed by, a processor 265 in device 260-1 in FIG. 2 and/or a processor 210 in server 205 of FIG. 2. For example, a computer program product having the computer-executable instructions may be stored in non-transitory computer-readable storage media of the respective device 260-1 and/or web server 210. The exemplary control program shown in FIG. 1, when executed, facilitates processing and displaying of user interfaces screens shown, for example, in FIG. 3 to FIG. 7, and controlling of their respective functions and interactions with a user. One skilled in the art can readily recognize that the exemplary process shown in FIG. 1 may also be implemented using a combination of hardware and software (e.g., a firmware implementation), and/or executed using logic arrays or ASIC.

At step 100 of FIG. 1, a file, such as e.g., a web page is received at e.g., a device 260-1 in FIG. 2 from a web server 205 of FIG. 2 and provided by device 260-1 to a user in response to a user request. The user request is, e.g., by a user entering the corresponding http or web address of the web page. This can be seen, e.g., in FIG. 3.

FIG. 3 shows an exemplary display screen 300 of a user device 260-1 according to the principles of the present invention. A user may enter a http or web address “www.mgo.com” 302 at an address bar 304 of a web browser 306. In response, web page 308 corresponding to that http address 302 will be displayed on the browser 306. Exemplary web page 308 comprises a plurality of texts on the page as shown in FIG. 3. In particular, in the embodiment shown in FIG. 3, the exemplary texts of the web page 308 include exemplary movie titles “MOVIE TITLE 1” 310-1, “MOVIE TITLE 2” 310-2, “MOVIE TITLE 3” 310-5, and exemplary names of actors “ACTOR 1” 310-3, “ACTOR 2” 310-4. The significance of these informational elements or keywords will be explained in detail to follow.

At step 110 of FIG. 1, for example, device 260-1 receives a user input for selecting one or more category identifiers for identifying a plurality of categories of topics for a user to obtain additional information on. Non-limiting examples of categories of topics may be one or more of the following: 1) types of people, 2) types of objects, 3) types of places, 4) types of media assets, 5) types of subjects, 6) types of interests, and etc. Exemplary categories and their identifiers are shown, e.g., in category selection area 320 of FIG. 3. In one alternative exemplary embodiment according to the principles of the present invention, the selection of the categories at step 110 may precede step 100 (of FIG. 1) of the file being provided by device 260-1 of FIG. 2. That is, for example, a user may select one or more pre-selected categories of topics for a device, or e.g., prior or during a browsing session, before a webpage is received, processed, and/or provided, and/or displayed to a user.

As shown in FIG. 3, a user may select one or more of the category identifiers 330-1 to 330-n in category selection area 320 of FIG. 3. A user may select these category identifiers 330-1 to 330-N by, e.g., moving a curser 380 over the identifiers and select them using e.g., one of the user I/O devices 280 of device 260-1 (such as e.g., a touch display or a mouse), as is well known in the art. In an exemplary embodiment shown in FIG. 3, category identifiers “Movies” 330-1 and “Actors” 330-2 have been selected as indicated by the highlight over the selected categories.

At step 120 of FIG. 1, one or more of the plurality of informational elements in a file (e.g., a web page) are identified in response to one or more of the selected category identifiers. This step is also shown, e.g., in user interface screen of FIG. 3. As described above, category identifiers “Movies” 330-1 and “Actors” 330-2 have been selected by a user. In response, one or more of informational elements or key words on web page 308 will be identified according to the principles of the present invention. In particular, since “MOVIE TITLE 1” 310-1, “MOVIE TITLE 2” 310-2, “MOVIE TITLE 3” 310-5 are informational elements or words related to movies, and “ACTOR 1” 310-3 and “ACTOR 2” 310-4 are actor names, they will be the elements on the web page 308 to be identified, according to the category identifiers “Movies” 330-1 and “Actors” 330-2 selected.

In one exemplary embodiment, the identified informational elements or keywords 310-1 to 310-5 on web page 308 may additionally be highlighted to give a user a visual indication of which informational elements or keywords on the web page 308 have been identified, as shown in FIG. 3.

In another embodiment, a user instead of first selecting one or more category identifiers as described at step 110 of FIG. 1, may highlight one informational element (e.g., “MOVIE TITLE 1” 310-1) first. In response, all the other informational elements in the file 308 associated with the corresponding category “Movies” will be automatically identified, and/or highlighted to the user. Additionally, if a second different informational element/keyword corresponding to a second different category, then again all informational element/keywords defined in that category are identified and/or highlighted automatically as well. The different sets of informational elements/keywords corresponding to the different categories may be highlighted, e.g., in different colors.

The identification step 120 of FIG. 1 described above is accomplished by obtaining information from an exemplary data structure of an exemplary database as shown in FIG. 7. FIG. 7 shows an exemplary data structure 700 of an exemplary database (e.g., element 225 and/or element 285 of FIG. 2) according to the principles of the present invention. Each category identifier 710-1 to 710-n respectively identifies a corresponding category of topics such as, e.g., “ACTORS” 710-1, “MOVIES” 710-2, and “CARS” 710-3. For each category, one or more corresponding informational elements or keywords 720-1 to 720-n of FIG. 7 are listed in the first column 740 data structure 700. These are the informational elements/keywords which, e.g., a processor 210 of FIG. 2 and/or a processor 265 will search and identify in a file as described above in connection with step 120 of FIG. 1, when their associated respective categories are chosen.

In addition, for each of the listed corresponding informational elements or keywords 720-1 to 720-n in column 740, one or more associated supplemental informational elements to be used to supplement the original file are specified in the second column 750 of data structure 700. As shown in FIG. 7, associated supplemental information may comprise, e.g., one or more of: a graphical image (e.g., 730-1 to 730-n), a text string (e.g., 735-1 to 735-n), and an internet link (e.g., 737-1 to 737-n). In one exemplary embodiment not shown in FIG. 7, the supplemental information may be an audio file which is played when a user highlights, selects and/or hovers over (e.g., via a cursor 680 of FIG. 6 in combination with a user selection device 280 of FIG. 2, such as e.g., a mouse) the associated information elements. Therefore, supplement information according to the principles of the present invention is capable of providing visual as well as audio feedbacks.

In an exemplary embodiment, a third column 790 of exemplary data structure 700 also specifies one or more hypertext links or links when a user, e.g., selects or hovers over one of the corresponding supplemental elements listed in column 750.

In one exemplary embodiment, more than one links may be associated with a supplemental element (see, e.g., 795-2 and 795-3; 795-6 and 795-7 of FIG. 7). Detailed explanation on how a user may select one of these links will be described later in connection with user interface screen of FIG. 6.

At step 130 of FIG. 1, the original file or web page 308 is supplemented with one or more associated supplemental informational elements listed in column 750 of FIG. 7 to provide a supplemented file or web page, in response to identification of one or more of the corresponding informational elements listed in column 740 of FIG. 7. At step 140, a supplemented file or web page having one or more of the supplemental informational elements may be displayed to a user. An example of such a supplemented file or web page is illustrated in FIG. 4.

FIG. 4 shows a supplemented file or web page 408, supplemented from an original file or web page 308 of FIG. 3, being provided and displayed on a display screen 400 of FIG. 4 of a user device 260-1 of FIG. 2, according to the principles of the present invention. The supplemental elements 440-1 to 440-12 of FIG. 4 are obtained, e.g., from information of an exemplary data structure 700 of a database shown in FIG. 7 and described in detail previously.

As shown in FIG. 4, informational element/keyword word “MOVIE TITLE 1” 310-1 now has supplemental elements 440-1 to 440-4. That is, e.g., the formatting of the original web page 308 in FIG. 3 is modified to incorporate e.g., a first supplemental element “Movie Title 1 Poster Art” graphical image 440-1 corresponding to the poster art of the “Movie Title 1” 310-1. Likewise, additional supplemental informational elements 440-2 to 440-4 are also incorporated and placed below informational element/key word “MOVIE TITLE 1” 310-1. For example, “Movie 1 Actor A Picture” 440-2 and “Movie 1 Actor B Picture” 440-3 may represent pictures or graphical images of different actors that starred in “Movie Title 1” 310-1. “Movie 1 Music Album Cover Art” 440-4 may correspond to album cover art of the soundtrack of “Movie Title 1” 310-1.

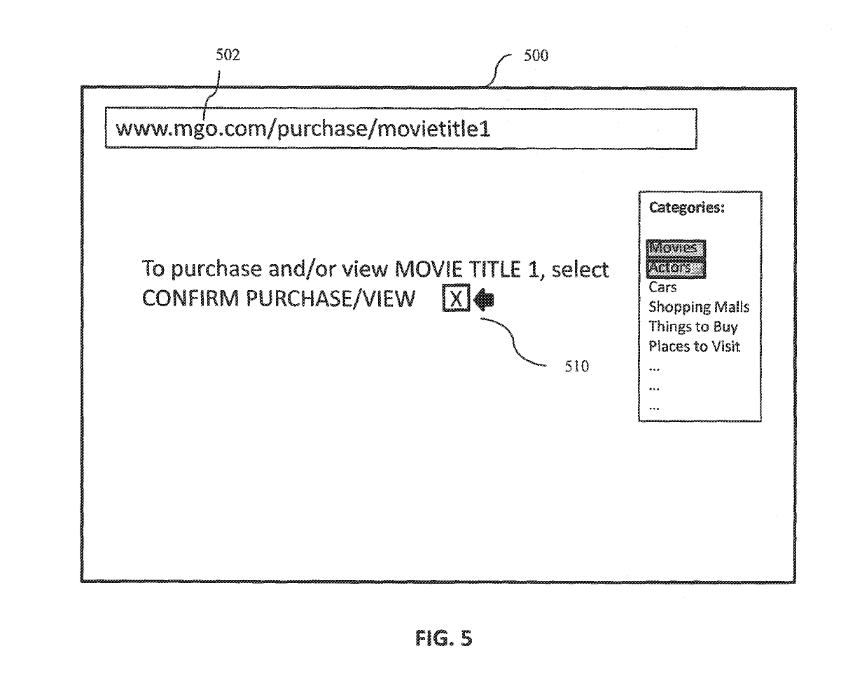

As described above in connection with FIG. 7, an exemplary embodiment of the present invention provides one or more hyperlinks (e.g., shown in column 790 of FIG. 7) so that a user will be shown and/or directed to those links when a supplemental element is selected or highlighted. For example, at step 150 of FIG. 1, when a user selects a supplemental element, e.g., 440-1 of FIG. 4, the user is linked to a web site or http address shown in 502 of FIG. 5 and presented with an option to purchase the associated media asset, “Movie Title 1” 310-1, as shown in 510 of FIG. 5. Similarly, when a user selects “Movie 1 Music Album Cover Art” 440-4 corresponds to the soundtrack of “Movie Title 1” 310-1, a user may be linked to a website where the music of the movie can be purchased and/or played back via a corresponding media asset service.

As described above, other exemplary types of linking are possible. For example, actor pictures 440-2 and 440-3 of FIG. 4 may be linked to biographical information of an actor from e.g., imdb.com, a web page dedicated to an actor, and/or the like. One exemplary embodiment when more than one links are associated with a supplemental element is shown in FIG. 6.

FIG. 6 shows that when a user, e.g., hovers, highlights and/or selects a supplemental element 440-2 (e.g., via a cursor 680 of FIG. 6 in combination with a user selection device 280 of FIG. 2, such as e.g., a mouse), the available hyperlinks or web links (e.g., 660-1 and 660-2) corresponding to that supplemental element 440-2 are shown to the user, e.g., in a pop-up area 680. The user can then select either of the links 660-1 and 660-2 he or she wants to navigate to, if more than one links are available.

Other informational elements on the original web page 308 of FIG. 3 may be supplemented with supplemental information elements and hyperlinked similarly, as shown in FIG. 4. For example, “Movie Title 2” 310-2 of FIG. 3 is presented in a similar manner as described above for “Movie Title 1” 310-1, where graphic representations of “Movie Title 2 Poster Art” 440-5 links to a media asset representation of “Movie Title 2” 310-2, “Movie 2 Actor C Picture” 440-6 links to biographical information of an actor C, “Movie 2 Actor D Picture” 440-7 links to a biographical information of an actor D, and the graphical presentation of “Movie 2 Music Album Cover” 440-8 links to the music of “Movie Title 2” 310-2.

Also in FIG. 4, supplemental informational element 440-9 corresponding to informational element/keyword “Actor 1” 310-3 may represent information about the actor 1. Supplemental informational elements 440-8 and 440-9 are graphic elements which may represent movies “Q” and “R” which actor 1 has appeared in. They may be linked to movie to assets starting actor 1 for view and/or purchase. Likewise, supplemental graphical elements 440-11 and 440-12 corresponding to video media assets of two different television shows S and T may be presented as shown in FIG. 4.

At step 160 of FIG. 1, exemplary information in an exemplary data structure of an exemplary database as shown in FIG. 7 are defined and populated according to the principles of the present invention. Details of exemplary implementations of step 160 are further illustrated in FIG. 8 and described below.

According to one exemplary embodiment of the present invention, default sets of information (shown e.g., in FIG. 7) may be pre-populated. This can either be provided by a web server 205 of FIG. 2, as illustrated by element 810 of FIG. 8, and/or locally from a local database of a device 260-1, as illustrated by element 820 of FIG. 8. In one exemplary embodiment, web server 205 may populate the default sets of information via a web crawler server as shown by element 830 of FIG. 8, or user device may directly implement and use a web crawler as shown by element 840 of FIG. 8.

Modern web-search can be done by search engines called “Web Spiders” or “Web Crawlers” and are used for data grabbing and gathering. This technology is well known in the art (see, e.g., http://en.wikipedia.org/wiki/Web_crawler). Such a web-crawler typically needs some information such as, e.g., a start page, a depth of search tree and wanted details (e.g., years, links, and etc.). The web crawling of the categories of informational elements or keywords according to the principles of the present invention may be provided by, e.g., web server 205 or a device 260-1 as noted before. For example, information on informational elements/keywords corresponding to movies and actor categories could be grabbed from e.g., the following databases:
http://en.wikipedia.org/wiki/Lists_of_actors
Apple iTunes and iTunes store
www.imbd.com (international movie data base)
local contact/address lists
audio and/or video playlists of a user device

FIG. 8 also illustrates other exemplary methods of populating a local database of information to be used by e.g., device 260-1 according to the principles of the present invention. Besides having predetermined default sets of information either provided by a web server remotely (e.g., 810, 830 of FIG. 8), or locally in a user device 260-n (e.g., 820, 840 of FIG. 8), a user can also define user-defined sets of informational elements or keywords for one or more corresponding user-defined categories as shown in element 850 of FIG. 8. As shown in element 850, one exemplary way of doing this is for a user to enter the relevant information in an exemplary data structure shown e.g., in FIG. 7, manually via e.g., a keyboard.

Furthermore, as shown in element 890 of FIG. 8, an exemplary embodiment of the present invention may be that an application provider of the present invention may allow or provide different personalized sets of information from different users of the same application to be able to be exchanged and/or downloaded to the local device 260-1. For example, each personalized set of information may have different emphasis on different categories of topics, and thus would tend to have more informational elements/key words for the emphasized categories.

In one exemplary embodiment, one or more of the above described exemplary methods of gathering the sets of information may be combined to form combined information sets to be used by an end-user device, as shown in element 805 of FIG. 8.

While several embodiments have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present embodiments. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings herein is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereof, the embodiments disclosed may be practiced otherwise than as specifically described and claimed. The present embodiments are directed to each individual feature, system, article, material and/or method described herein. In addition, any combination of two or more such features, systems, articles, materials and/or methods, if such features, systems, articles, materials and/or methods are not mutually inconsistent, is included within the scope of the present embodiments.

1. A method comprising, at an end user device:
providing a file containing a plurality of informational elements; and
receiving a user input for selecting at least one of a plurality of category identifiers for identifying a plurality of categories;
identifying at least one of the plurality of informational elements in the file in response to the at least one of the category identifiers; and
supplementing the file in response to the identified at least one of the plurality of informational elements with at least one supplemental informational element to provide a supplemented file.

2. The method of claim 1 wherein the file containing the plurality of informational elements is provided in response to a second user input.

3. The method of claim 1 wherein the supplemental element comprises one or more of: a graphical image, a text string, an internet link, and audio feedback.

4-6. (canceled)

7. The method of claim 1 wherein the plurality of categories comprise one or more of the following: types of people, types of objects, types of places, types of media assets, types of subjects, and types of interests.

8. The method of claim 1 further comprising a step of displaying the plurality of category identifiers for user selection.

9-11. (canceled)

12. An apparatus comprising:
a user interface device for receiving a user input for selecting at least one of a plurality of category identifiers for identifying a plurality of categories; and
a processor for providing a supplemented file;
wherein the supplemented file is generated from a file containing a plurality of informational elements, at least one of the plurality of informational elements in the file is identified in response to the at least one of the category identifiers, and the file is supplemented in response to the identified at least one of the plurality of informational elements with at least one supplemental informational element to generate the supplemented file.

13. The apparatus of claim 12 wherein the file containing the plurality of informational elements is provided in response to a second user input.

14. The apparatus of claim 12 wherein the supplemental information element comprises one or more of: a graphical image, a text string, an internet link, and audio feedback.

15-17. (canceled)

18. The apparatus of claim 12 wherein the plurality of categories comprise one or more of the following: types of people, types of objects, types of places, types of media assets, types of subjects, and types of interests.

19. The apparatus of claim 12 wherein the plurality of category identifiers are displayed.

20-21. (canceled)

22. A computer program product stored in a non-transitory computer-readable storage media comprising computer-executable instructions for:
providing a file containing a plurality of informational elements;
receiving a user input for selecting at least one of a plurality of category identifiers for identifying a plurality of categories;
identifying at least one of the plurality of informational elements in the file in response to the at least one of the category identifiers; and
supplementing the file in response to the identified at least one of the plurality of informational elements with at least one supplemental informational element to provide a supplemented file.

23. A method, comprising:
receiving by a processor a user input containing at least one of a plurality of category identifiers; and
storing in a memory a data file containing at least one of a first plurality of informational elements and at least one supplemental informational element of a plurality of supplemental informational elements that supplements said data file if a category of said at least one of said first plurality of informational elements is identified in response to said at least one of said plurality of category identifiers.

24-26. (canceled)

27. An apparatus, comprising:
a processor for receiving a user input containing at least one of a plurality of category identifiers; and
a memory for storing a data file containing at least one of a first plurality of informational elements and at least one supplemental informational element of a plurality of supplemental informational elements that supplements said data file if a category of said at least one of said first plurality of informational elements is identified in response to said at least one of said plurality of category identifiers.

28-29. (canceled)
